(19) United States
(12) Patent Application Publication
(10) Pub. No.: US 2026/0357902 A1
(43) Pub. Date: Nov. 12, 2026

(54) VALVE ASSEMBLY FOR A LIQUID DISPENSING UNIT AND LIQUID DISPENSING UNIT FOR WATER PURIFICATION SYSTEM

(71) Applicant: Merck Patent GmbH, Darmstadt (DE)

(72) Inventors: Agnes de Varine, Paris (FR); Thierry Cassou, Montigny le Bretonneux (FR); Laurent Moreau, Versailles (FR)

(21) Appl. No.: 19/135,226

(22) PCT Filed: Dec. 6, 2023
(86) PCT No.: PCT/EP2023/084409

§ 371 Date: Jun. 3, 2025

(30) Foreign Application Priority Data
Dec. 9, 2022 (EP) 22290069.8

(51) Int. Cl. F16K 3/08; C02F 1/00; F16K 3/34

(52) U.S. Cl. CPC F16K 3/08; C02F 1/00; F16K 3/34; C02F 2201/005; C02F 2209/40

(57) ABSTRACT

The present application relates to a valve assembly (10) for a liquid dispensing unit and to a liquid dispensing unit for a water purification system as well as to a water purification system as such.

### TECHNICAL FIELD

The present invention relates to a valve assembly for a liquid dispensing unit and to a liquid dispensing unit for a water purification system as well as to a water purification system as such.

### BACKGROUND

Most existing water purification and distribution systems for ultrapure water use a solenoid valve to control the opening and closing of the dispensing unit. However, solenoid valves only have an on-off setting. Therefore, some devices couple this solenoid valve with a motorized valve to allow a user to precisely control the dispense flowrate, from drop-by-drop (or “dropwise”) dispensing to high flowrates. Both, the solenoid valve and the motorized valve, can be integrated together in the dispensing unit, or the motorized valve can be placed in a remote main system and only the solenoid valve in the dispensing unit.

Prior art water purification and distribution systems for ultrapure water are, for example, described in U.S. Pat. No. 5,925,240 A, WO 2010/043899 A1, and U.S. Pat. No. 11,035,484 B2.

These existing systems have several drawbacks:
(i) A PCB (printed circuit board) with electronics must be integrated in the dispensing unit, with power transferred from the remote main system to the distribution or dispensing unit;
(ii) the solenoid valve and the motorized valve together are bulky components, which limit the integration and design options of the dispensing unit, to maintain ergonomic operation;
(iii) energizing the activation coil of a solenoid valve over a long period of time can cause heating, which can compromise the quality of the purified water dispensed from the distribution or dispensing unit; and
(iv) in a system with more than one distribution or dispensing unit, a motorized valve coupled with several solenoid valves only allows for one flowrate setting at a time and it is not possible to set different flowrates for the different distribution or dispensing units.

Valve assemblies with pairs of ceramic discs with openings, windows or pockets opened and closed by relative rotation of the discs are commonly used in fluid distribution systems. One disc is kept fixed in a housing, while the other one is mobile and is driven in rotation to align or separate the disc openings, windows, or pockets in order to let fluid flow through the valve assembly or not.

With good surface properties the discs adhere together, and sealing is achieved when the discs' openings, windows or pockets are not facing (or overlapping) each other. This concept uses ceramic materials as they can have excellent surface properties after rectification, which means that fluid cannot flow in between the discs when they are in the closed position. Moreover, ceramic materials are extremely hard and resistant to wear so that ceramic valves can be used for millions of cycles without sealing being compromised. Therefore, this technology is commonly used in water taps sold on the consumer market. The existing designs, however, do not allow precision dispensing down to a drop-by-drop flow rate and/or are operable only by applying significant force or momentum requiring gripping of an actuator by the full hand of the user.

The invention aims at providing a valve assembly for a liquid dispensing unit and a liquid dispensing unit for a water purification system, solving at least one of the problems associated with existing solutions.

The invention in particular aims at providing a valve assembly for a liquid dispensing unit and a liquid dispensing unit for a water purification system (preferably a pure or ultrapure water purification and dispensing system), that can control opening and closing of the distribution as well as the flow rate of distribution down to drop-by-drop (or “dropwise”) dispensing while reducing the size, costs and environmental impact by reducing the number of components and avoiding electronics, further allowing an easy, ergonomic operation, and/or an easy and robust assembly.

### SUMMARY

To solve the indicated problems, the present invention provides a valve assembly for a liquid dispensing unit as defined by claim 1 and a liquid dispensing unit for a water purification system as defined by claim 15. Preferred embodiments of the valve assembly and of the liquid dispensing unit are defined in the dependent claims.

The present invention in particular provides a valve assembly for a liquid dispensing unit comprising a pair of first and second discs to be rotated relative to each other with mutually facing first and second sealing contact surfaces arranged to at least partly slide in contact with each other, wherein the first disc has at least one window, wherein the second disc has a solid portion arranged to completely cover and thus to close the at least one window of the first disc in a fully closed rotational position, and an opening portion arranged to at least partially expose the at least one window of the first disc in a fully open rotational position.

Preferably, the solid portion of the second disc that is arranged to completely cover to close the at least one window of the first disc in the fully closed rotational position is formed so as to include a portion of the second sealing contact surface that overlaps the first sealing contact surface of the first disc surrounding an edge of the window by a sealing zone with a width of at least 1.5 mm, preferably at least 2.0 mm.

Preferably, the first and second sealing contact surfaces of the pair of first and second discs arranged to at least partly slide in contact with each other have a surface roughness Ra of at most 0.60 μm, and/or a surface flatness of at most 0.80 μm, and are preferably polished or ground.

Preferably, the mutually facing first and second sealing contact surfaces of the pair of first and second discs are arranged such that a percentage of 50-80%, preferably 55-75%, most preferably 60-70% of the first and second sealing contact surfaces are sliding in contact with each other between the fully closed rotational position and the fully open rotational position.

Preferably, the second disc is freely floating in contact with the first disc or is biased towards the first disc by a biasing member.

Preferably, the at least one window of the first disc has a notch/dent recessed into the material of the first disc from the plane defined by the first sealing contact surface of the first disc at an/the edge of the at least one window at a side where the exposure of the at least one window starts upon movement of the second disc from the fully closed rotational position in the direction towards the fully open rotational position.

Preferably, the notch/dent has a pointed tip widening and/or deepening gradually towards the at least one window.

Preferably, the at least one window has an inclination or ramp at a sidewall adjacent to a/the side where the exposure of the at least one window starts upon movement of the second disc from the fully closed rotational position in a/the direction towards the fully open rotational position such that the free opening width of the at least one window in the thickness direction of the first disc becomes gradually narrower with distance from the plane of the first sealing contact surface.

Preferably, the valve assembly is dimensioned so as to provide, within the rotational angular range of the relative movement between the fully closed rotational position and the fully open rotational position, a flowrate through the at least one window from dropwise, preferably 20 mL/min, up to 2 L/min.

Preferably, the rotational angular range between the fully closed rotational position and the fully open rotational position is 50°-70°, preferably 55°-65°, and most preferably about 60°.

Preferably, the first disc is provided with positioning notches for preventing a rotation and defining a mounting position in a receptacle of a liquid dispensing unit, the positioning notches being formed and/or arranged unsymmetrical about a circumference of the first disc.

Preferably, the second disc is provided with one or more driver recess/recesses and/or protrusion/protrusions on a side opposite to the second sealing contact surface, for engagement with a rotary actuator of a liquid dispensing unit.

Preferably, the first disc has a circular outer periphery, and the second disc has a non-circular outer periphery with the opening portion arranged to at least partially expose the at least one window of the first disc radially recessed from the outer periphery.

Preferably, the first disc and/or the second disc are made of a ceramic material, preferably aluminum oxide ceramic.

The present invention in particular also provides a liquid dispensing unit for a water purification system, comprising a supply piping for purified water, an outlet for purified water, and a valve assembly according to the invention arranged in a receptacle of a housing such that the valve assembly can control the volume or rate of the flow of purified water from the supply piping to the outlet.

Preferably, the first disc of the valve assembly is rotationally fixed in position within the receptacle such that the at least one window communicates with the outlet, and the second disc is mounted in the receptacle so as to freely float in contact with the first disc and such that the first and second sealing contact surfaces are pressed against each other by the water pressure from the supply piping acting on the second disc.

Preferably, the second disc of the valve assembly is engaged with a manually operable rotary actuator for rotatingly driving the second disc relative to the first disc between the fully closed rotational position and the fully open rotational position.

Furthermore, the present invention provides a water purification system comprising such liquid dispensing unit as defined herein.

### BRIEF DESCRIPTION OF THE DRAWINGS

FIG. 1 shows a perspective schematic view of an exemplary first disc of a valve assembly.

FIG. 2 shows a perspective schematic view of an exemplary second disc of the valve assembly.

FIG. 3 shows a schematic top view of the valve assembly with the first and second discs of FIGS. 1 and 2 superposed on each other.

FIG. 4 shows a schematic partial cross-sectional side view of an exemplary dispensing unit provided with the valve assembly.

FIG. 5 shows a schematic cross sectional top view of the exemplary dispensing unit with the valve assembly in the closed position (left view) and in the open position (right view).

### DETAILED DESCRIPTION

The valve assembly of the present invention is a mechanical valve including a single pair of discs, preferably made from ceramic material, that can be integrated in the dispensing unit of water purification systems to replace both, the motorized valve and the solenoid valve. This single pair of discs can be used to control both, the opening and closing of the flow through the valve assembly, as well as the dispensing flowrate from dropwise dispensing to high flowrates, i.e. from 20 mL/min to 2 L/min.

The mechanical valve assembly in consequence of its reduced size and complexity provides one or more of the following advantages over existing products:
(i) The ability to have several dispensing units for dispensing at different flowrates at the same time in a single water purification system;
(ii) the size of the dispensing unit can be reduced by removing the solenoid valve (and the motorized valve if provided) and the PCB from the dispensing unit and/or the distribution unit—this provides an improved ergonomic handling of the dispensing unit;
(iii) the number of components and the complexity of the dispensing unit and/or the distribution unit can be reduced—in particular, avoiding the electronics means that no power or control circuits must be provided from the main system with the purification stage to the dispensing unit and a connection between the main system to the dispensing unit may be reduced to a dual or single tubing instead of two tubings and electronic cables, which all have to be integrated in an outer sleeve or bound together by suitable means as, for example, cable ties;
(iv) the simplification of the structure and lack of electronics is also beneficial from an environmental perspective, reducing the carbon footprint of the dispensing unit and/or the distribution unit and improving its recyclability;
(v) the possibility to omit electronic parts from the dispensing unit and/or distribution unit further simplifies maintenance and repair of the unit in case of need as no electronic connections need to be made;
(vi) from a manufacturing perspective, the valve assembly and the liquid dispensing unit provided with it provide for a simplified and more robust, i.e. error free assembly; and
(vii) finally, the valve assembly and the liquid dispensing unit provided with it enhance the freedom of design: having electronic parts close to hydraulic components in a small and closed space is a risk. This constrains the design of water distribution or dispensing units, forcing a flow entry from the lower part of a gun in most existing products. The lack of electronics made possible by the use of a mechanical valve assembly simplifies the constraints on the design of the distribution or dispensing unit and lowers the risks from that perspective.

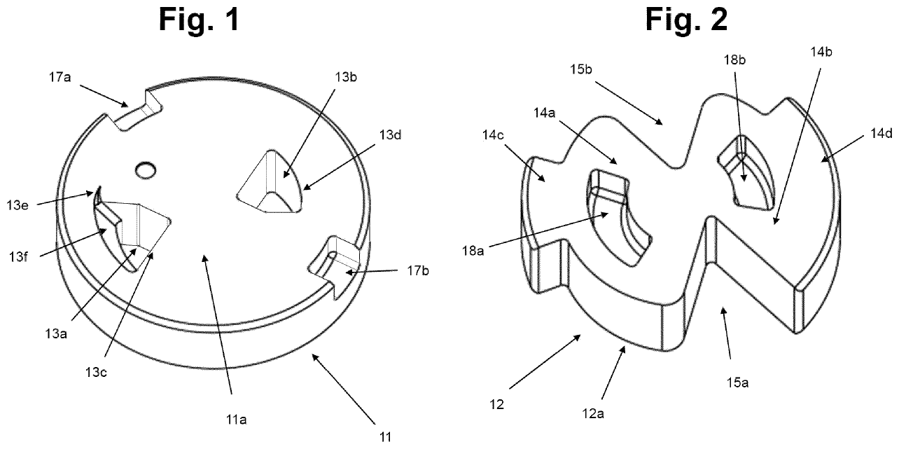

The invention is now described in detail on the basis of preferred exemplary embodiments by reference to the attached exemplary schematic drawings FIGS. 1 through 5.

The valve assembly for a liquid dispensing unit and the liquid dispensing unit for a water purification system of the invention are now described in connection with an exemplary embodiment.

The valve assembly 10 for a liquid dispensing unit 1 (see FIG. 4) comprises a pair of first and second discs 11,12 to be rotated relative to each other with mutually facing first and second sealing contact surfaces 11a,12a arranged to at least partly slide in contact with each other.

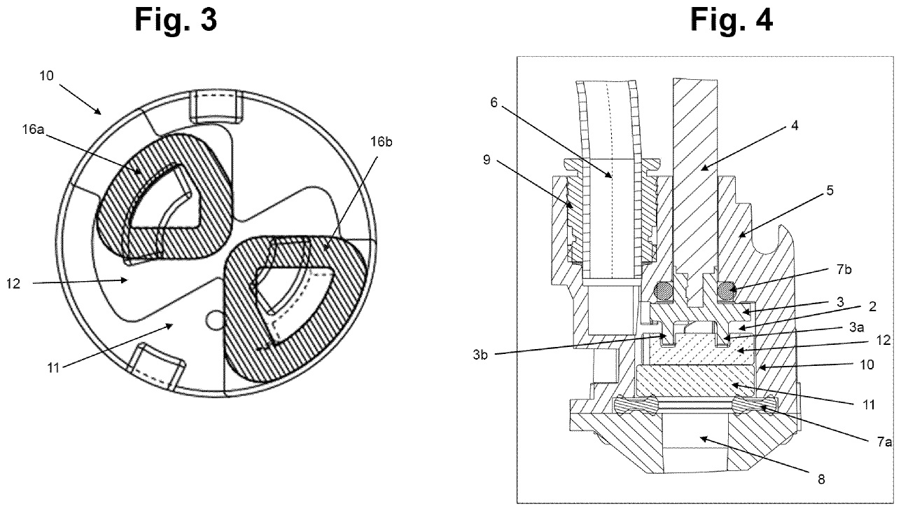

The first disc 11 has at least one window 13a,13b (two in the embodiment at positions opposite to each other through the center of the disc). The second disc 12 has a solid portion 14a,14b arranged to completely cover and thus to close in an axial direction the at least one window 13a,13b of the first disc 11 in a fully closed rotational position (shown in FIG. 3), and an opening portion 15a,15b arranged to at least partially expose the at least one window 13a,13b of the first disc 11 upon relative rotation in a progressing manner until it is positioned in a fully open rotational position. Here, too, two solid portions 14a,14b and two opening portions 15a,15b are provided in the embodiment complementary to the two windows 13a,13b of the first disc.

While two of the windows and corresponding opening portions and solid portions are provided in a rotationally symmetrical manner, the number can be one each or more than two distributed about a circumference.

The windows 13a,13b extend through the thickness of the first disc in the axial direction and serve as flow paths for the fluid through the valve assembly in the axial direction as described later.

The solid portion(s) 14a,14b of the second disc 12 that is/are arranged to completely cover and thus to close the window(s) 13a,13b of the first disc 11 in the fully closed rotational position is/are formed so as to include a portion of the second sealing contact surface 12a that overlaps the first sealing contact surface 11a of the first disc 11 within a closed sealing zone 16a,16b, respectively surrounding an edge 13c,13d of the window(s) 13a,13b. The sealing zone 16a,16b has a width of at least 1.5 mm, preferably at least 2.0 mm, measured perpendicularly to the edge or more precisely perpendicularly to a tangent to the edge within the planes of the first and second sealing contact surfaces 11a,12a to guarantee sealing in the fully closed position (see FIG. 3). Sealing with the receptacle of a housing of a dispensing unit in which the valve assembly is integrated is achieved on the surface opposite to the first sealing contact surface 11a of the first disc 11 (which may be the lower surface of the first disc if arranged as the lower disc in the example of FIG. 4) and therefore requires a certain circular area on the outside of the surface with no openings. These two requirements combined with the need to maximize the opening area of the windows to set a desired maximum flow rate determine the sizes and shapes and features of the two discs.

The first disc 11 and/or the second disc 12 are preferably made of a ceramic material. As the valve assembly is to be integrated in a distribution or dispensing unit for ultrapure water, the type of ceramic material used is to be selected to avoid any contamination to the ultrapure water. Aluminum oxide ceramic is a suitable and preferred material. However, depending on the circumstances and if the required sealing properties of the sealing contact surfaces of the discs can be realized, another material including metal or alloys or a different base material with a suitable coating including a ceramic coating are possible.

The first disc 11 in the embodiment has a circular outer periphery and the second disc 12 has a non-circular outer periphery with the opening portion 15a,15b arranged to at least partially expose the at least one window 13a,13b of the first disc 11 radially recessed from the outer periphery (see FIG. 2). The discs may, however, have a peripheral shape other than circular. If the peripheral shape is “not round”, it may facilitate holding at least one disc (i.e. the stationary disc) in a receptacle of a dispensing unit to prevent rotation by engagement with a suitable corresponding shape of a recess or a protrusion.

The first disc 11 is provided with positioning notches 17a,17b at an outer periphery for preventing—in a mounted state in a receptacle 2 of the dispensing unit 1 as shown in FIG. 4—a rotation and for defining a unique mounting position in the receptacle 2. The positioning notches 17a,17b are formed and/or arranged asymmetrically about a circumference of the first disc 11 in order to define the unique mounting position.

The second disc 12 is provided with one or more driver recess/recesses 18a,18b and/or protrusion/protrusions (not shown) on a side opposite to the second sealing contact surface 12a in the axial direction, for engagement with a rotary actuator 3 of the liquid dispensing unit 1. In the embodiment the recesses 18a,18b are shallow pockets or grooves with a closed bottom that do not extend through the thickness of the second disc in the axial direction. The rotary actuator 3 is provided with matching protrusions 3a,3b (see FIG. 4) for engaging with the recesses 18a,18b. The shape or contour of the recesses 18a,18b and matching protrusions 3a,3b is unsymmetrical in order to define a unique mounting orientation or more precisely a defined rotational position of the actuator 3 where the engagement is possible.

The sealing properties of the discs 11, 12 depend mainly on the percentage of the sealing contact surfaces 11a 12a of the discs that are effectively in contact at the microscopic level. The disc sealing contact surfaces are therefore processed to reach a pre-set percentage of the surfaces in contact between the two discs. A percentage that is too low would compromise sealing, and a percentage too high would cause excessive efforts of operation. As there are no external forces applied on the discs in the integration in the dispensing unit as described below, this percentage of the disc surfaces in contact, together with the water pressure and the friction forces of the seal on the driving actuator, are the only parameters that influence the operation efforts.

The first and second sealing contact surfaces 11a,12a of the pair of first and second discs 11,12 that are arranged to at least partly slide in contact with each other have a surface quality or surface roughness Ra of at most 0.60 μm, more preferably of at most 0.50 μm, most preferably of at most 0.40 μm, and/or a flatness of at most 0.80 μm, preferably of at most 0.70 μm, most preferably of at most 0.60 μm, to create the fluid-tight sealing upon contact. Preferably the first and second sealing contact surfaces 11a,12a of the pair of first and second discs 11,12 are polished or ground.

The mutually facing first and second sealing contact surfaces 11a,12a of the pair of first and second discs 11,12 are arranged such that a percentage of 50-80%, preferably 55-75%, and most preferably 60-70% of the first and second sealing contact surfaces 11a,12a are sliding in contact with each other between the fully closed rotational position and the fully open rotational position.

The forces required to operate the valve assembly are directly proportional to the axial forces applied to the discs:

Friction forces=normal forces*friction coefficient

Since the valve assembly is to be integrated in a water dispensing unit, for example in the form of a “gun” that the user will hold with just one hand and operate with his thumb within a relatively small angular moving range, low operation forces are critical. This differs from similar fluid valves that are driven by a motor or ones where a full hand is used to operate the valve, on a large angular range.

It is therefore critical to reduce as much as possible the force required to open and close the valve assembly, for ergonomic operation. To that effect, the axial forces that apply to the discs are to be minimized in order to limit the friction forces between the discs to a minimum. Extensive tests showed that water pressure generally is sufficient to press the discs together and achieve sealing, with no additional forces required.

In the integration of the valve assembly in a dispensing unit exemplified in FIG. 4, the second disc 12 is arranged as an upper disc and is preferably mounted freely floating in contact with the first disc 11 in order to minimize forces of operation of the water dispensing unit. There is an axial stop in an upper manifold to determine and fix the altitude of the first or lower disc and sealing is achieved between the first disc 11 and the housing with a custom seal 7a, shown in FIG. 4. There is then a functional gap between the driving actuator 3 (i.e. of the protrusions 3a,3b in the recesses 18a,18b of the second disc 12) to guarantee that no axial forces—other than those resulting from the pressure of the fluid acting on the second disc 12 and pressing it against the first disc 11—are applied between the discs.

Reduced forces and improved ergonomics of operation also can be achieved not only by the optimization of the disc properties and the integration with the freely floating second or upper disc, but also by an optimization of the rotating seal on the driving actuator.

In certain applications it might be beneficial, to enhance the sealing effect, to slightly bias the second disc 12 towards the first disc 11, by a biasing member (not shown), for example an elastic member like an elastic seal (for example an O-ring) or spring arranged between the driving actuator 3 and the upper surface of the second disc 12. Such biasing member could, for example, be arranged in the space between the protrusions 3a,3b and the upper surface of the second disc 12 (not shown in the drawing).

For the intended use in a liquid dispensing unit for ultrapure water the disc design and the disc properties are optimized to enable a wide range of flowrates: good sealing must be achieved in the fully closed position and flowrates from stable and easy to reach dropwise dispensing up to 2 L/min when the valve assembly is fully open, with limited pressure drops are provided on a limited ergonomic angular range that allows operation when the liquid dispensing unit is to be used with just one hand and operated with the thumb, while the rest of the hand holds the device.

The discs of the valve assembly, in particular the dimensions and arrangement of the window(s) 13a,13b, of the solid portions 14a,14b and of the opening portions 15a,15b are thus configured to provide a rotational angular range between the fully closed rotational position and the fully open rotational position to be between 50°-70°, preferably 55°-65°, and most preferably about 60°.

The valve assembly 10 is dimensioned so as to provide, within the rotational angular range of the relative movement between the fully closed rotational position and the fully open rotational position, a flowrate through the at least one window (13a,13b) from dropwise, preferably 20 mL/min, up to 2 L/min.

To in particular provide the stable and easy to reach dropwise dispensing from the fully closed position at the beginning of the operating range (or, though in the following not directly described, correspondingly from the fully open position towards the end of the operating range) the at least one window 13a,13b of the first disc 11 has a notch/dent 13e recessed into the material of the first disc 11 from the plane defined by the first sealing contact surface 11a of the first disc 11 at an/the edge 13c,13d of the at least one window 13a,13b that is located at a side where the exposure of the at least one window 13a,13b starts upon movement of the second disc 12 from the fully closed rotational position in the direction towards the fully open rotational position (see FIGS. 1 and 3). Preferably, only one of the windows 13a,13b of the first disk 11 has a notch/dent 13e. Nevertheless, depending upon specific requirements both windows 13a,13b or—if disk 11 has more than two windows—any number of these may have such a notch/dent.

The notch/dent 13e has a pointed sharp tip that gradually and continuously widens in a horizontal direction defined by the extension of the plane of the first sealing contact surface and/or deepens gradually towards the at least one window 13a,13b in the direction perpendicular to that plane. In other words, the surface of the cross section of the notch/dent 13e increases towards the at least one window 13a,13b in the circumferential direction of the first disc 11.

Further, to smoothen the flow of the liquid upon further rotation of the second disc 12 beyond the range of the notch/dent 13e, the at least one window 13a,13b has an inclination or ramp 13f at a sidewall adjacent to the side where the exposure of the at least one window 13a,13b starts upon movement of the second disc 12 from the fully closed rotational position in the direction towards the fully open rotational position such that the free opening width or surface of the cross section of the at least one window 13a,13b in the thickness or axial direction of the first disc 11 becomes gradually narrower over at least a certain range with distance from the plane of the first sealing contact surface 11a.

As mentioned before the valve assembly of the invention is in particular designed and advantageous for use in a liquid dispensing unit 1 for a water purification system. The integration of the valve arrangement in a preferred embodiment of a liquid dispensing unit 1 is at least partially shown in the cross-sectional view of FIG. 4. The liquid dispensing unit 1 that is in the form of a “gun” to be held by a single hand of a user while the valve assembly is operated by the thumb comprises a housing 5, a supply piping 6 for purified water connected to a port 9 of the housing 5 directed towards the upper side, and an outlet 8 for purified water directed towards the lower side in a typical upright held orientation.

The valve assembly 10 according to the invention is arranged in a receptacle 2 of a housing 5 such that the valve assembly 10 can control the volume or rate of the flow of purified water from the supply piping 6 to the outlet 8. The receptacle 2 is in communication with the port 9 of the housing 5 and the outlet 8.

The first disc 11 of the valve assembly 10 is rotationally fixed in position within the receptacle 2 (for example by protrusions engaging with the positioning notches 17a,17b at the outer periphery of the first disc 11 (see FIG. 1) or by the mating shape of the receptacle such that the at least one window 13a,13b communicates with the outlet 8. The outer periphery of the surface of the first disc surrounding the lower opening of the window(s) is sealed against the housing 5 by means of an annular seal 7a such that all liquid entering the outlet 8 from the receptacle 2 must pass through the window(s) 13a,13b of the fist disc 11.

The second disc 12 is shown to be mounted in the receptacle 2 so as to freely float in contact with the first disc 11 and such that the first and second sealing contact surfaces 11a,12a are pressed against each other by only the water pressure from the supply piping 6 acting on the second disc 12 as described above.

The second disc 12 of the valve assembly 10 is engaged with a manually operable rotary actuator 3,4 for rotatingly driving the second disc 12 relative to the first disc 11 between the fully closed rotational position and the fully open rotational position within the above described rotational range. The rotary actuator comprises an axle 4 and a driver 3 connected with a lower end of the axle 4.

Though driver 3 and axle 4 may be made (i.e. essentially consists) of the same material, it is preferred that driver 3 and axle 4 are made of different materials. Preferably, driver 3 is made of (i.e. essentially consists) of a material that has a low content of leachables, i.e. has a low tendency to release contaminants. Non-limiting examples of materials suitable for driver 3 may be selected from the group consisting of polyacetal, and polypropylene. A preferred example of a material suitable for driver 3 is polyoxymethylene (POM). Preferably, axle 4 is made of a material having good mechanical strength, especially on torsion resistance, so as to allow for accurate and precise operation of the ceramic discs, which is particularly necessary to find the dropwise dispensing position. Non-limiting examples of such materials suitable for axle 4 may be selected from the group consisting of polyamides (PA), reinforced (e.g. with fiber reinforcement or talc) polyamides, and reinforced (e.g. with talc) polypropylene. A preferred example of a material suitable for axle 4 is polyphthalamide (PPA).

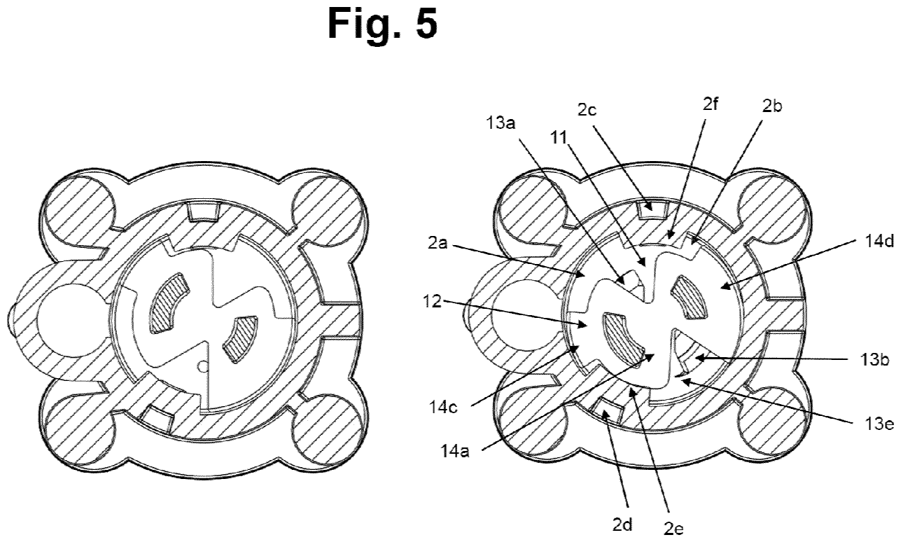

A part of the actuator, not shown in the drawing, extends to the outside of the housing 5 and is accessible for the thumb of the hand to be operated to rotationally drive the second disc 12 and can be shaped according to the desired ergonomics. The rotary actuator is sealed against the housing 5 by an O-ring or gasket 7b to prevent liquid from escaping the receptacle 2 other than through the outlet 8. The specific design of the actuator is not critical provided the floating positioning and contact of the second disc against the first disc is achieved without introducing additional axial forces in connection with the operation for rotation of the second disc from the fully closed to the fully open rotational position (see also FIG. 5).

In the embodiment the second disc 12 is provided with additional protrusions 14c,14d on an outer periphery that are inserted into corresponding peripheral grooves 2a,2b of the receptacle 2 so as to guide and limit the rotational range of the rotation of the second disc 12.

In addition to the considerations regarding hydraulic performance and usability, the shapes and features of the two discs are also optimized for a simple and robust assembly process, with very limited possibilities to misassemble the parts in the housings of the liquid dispensing unit. In particular, the positioning notches 17a,17b on the first disc 11 used to maintain the first disc in place are not symmetrical, so as to only fit in one position into the receptacle 2 in which it is integrated. The asymmetrical ribs 2c,2d in the receptacle 2 that are used to maintain the first or lower disc 11 in a fixed position also prevent the upper disc to be mounted in the wrong angular position (see FIG. 5).

The two protrusions 3a,3b (see FIG. 4) for engaging with the recesses 18a,18b in the second or mobile disc 12 used to drive valve operation with the rotating actuator 3,4 are also different from each other, to allow only one angular position relative to an axis of the actuator. This is important as the stops on the valve (fully open and fully closed) are defined between the axle and the housing 5.

Ribs 2e,2f between the peripheral grooves 2a,2b of the receptacle 2 are used for defining these stops and thus also influence the outer shape of the second or mobile disc 12 that should be free to rotate on its operating range despite these ribs 2e,2f.

The present valve assembly and liquid dispensing unit may be used in applications having different user requirements. For example, a user may want to use the present valve assembly and liquid dispensing unit for “volumetric dispensing”, i.e. dispensing a pre-defined volume of purified water from the liquid dispensing unit. In such case, it may be advantageous to pre-set the valve assembly as defined herein to a defined flow rate, opening and closing the flow of purified water through the supply piping for purified water through the valve assembly as defined herein to the outlet for purified water using a solenoid valve. Such solenoid valve may be actuated using any suitable actuator, such as a foot pedal, which gives the user freedom of using their hands. Alternatively the solenoid valve may be actuated by a simple switch or also by remote control.

Thus, the present liquid dispensing unit 1 optionally comprises a solenoid valve controlling the flow of purified water through the supply piping 6 for purified water through valve assembly 10 as defined herein to outlet 8 for purified water. Such solenoid valve may be placed at any location that allows controlling the flow of purified water through the supply piping 6 for purified water through valve assembly 10 as defined herein to outlet 8 for purified water. A suitable location may, for example, be before or at the entry of the purified water into supply piping, or at any place along the supply piping 6; preferably, such solenoid valve is placed before or at the entry of the purified water into supply piping 6.

Alternatively, such solenoid valve may be placed at the point of dispensing, i.e. outlet 8.

The present valve assembly may, of course, also be rotatingly actuated using a motor, preferably a servomotor or a stepper motor. Optionally, such motor may further comprise mechanical gears for reducing the actuating speed. Such motor is arranged in such a way that it either directly or indirectly (e.g. through an axle) rotate the second disc 12. For example, said motor may be placed such that it rotatingly drives axle 4.

The present liquid dispensing unit may be used as part of a water purification system, particularly a water purification system for providing pure or ultrapure water in a laboratory environment. Thus, the present application also provides for a water purification system comprising such liquid dispensing unit as defined herein.

1. A valve assembly (10) for a liquid dispensing unit (1) comprising:
a pair of first and second discs (11, 12) to be rotated relative to each other with mutually facing first and second sealing contact surfaces (11a, 12a) arranged to at least partly slide in contact with each other,
wherein the first disc (11) has at least one window (13a, 13b), and
wherein the second disc (12) has a solid portion (14a, 14b) arranged to completely cover to close the at least one window (13a, 13b) of the first disc (11) in a fully closed rotational position, and an opening portion (15a, 15b) arranged to at least partially expose the at least one window (13a, 13b) of the first disc (11) in a fully open rotational position.

2. The valve assembly (10) according to claim 1, wherein the solid portion (14a, 14b) of the second disc (12) that is arranged to completely cover to close the at least one window (13a, 13b) of the first disc (11) in the fully closed rotational position is formed so as to include a portion of the second sealing contact surface (12a) that overlaps the first sealing contact surface (11a) of the first disc (11) surrounding an edge (13c, 13d) of the window (13a, 13b) by a sealing zone (16a, 16b) with a width of at least 1.5 mm.

3. The valve assembly (10) according to claim 1, wherein the first and second sealing contact surfaces (11a, 12a) of the pair of first and second discs (11, 12) arranged to at least partly slide in contact with each other have a surface roughness Ra of at most 0.60 μm, and/or a surface flatness of at most 0.80 μm, and are optionally polished or ground.

4. The valve assembly (10) according to claim 1, wherein the mutually facing first and second sealing contact surfaces (11a, 12a) of the pair of first and second discs (11, 12) are arranged such that a percentage of 50-80%, of the first and second sealing contact surfaces (11a, 12a) are sliding in contact with each other between the fully closed rotational position and the fully open rotational position.

5. The valve assembly (10) according to claim 1, wherein the second disc (12) is freely floating in contact with the first disc (11) or is biased towards the first disc (11) by a biasing member.

6. The valve assembly (10) according to claim 1, wherein the at least one window (13a, 13b) of the first disc (11) has a notch/dent (13e) recessed into the material of the first disc (11) from the plane defined by the first sealing contact surface (11a) of the first disc (11) at an edge (13c, 13d) of the at least one window (13a, 13b) at a side where the exposure of the at least one window (13a, 13b) starts upon movement of the second disc (12) from the fully closed rotational position in the direction towards the fully open rotational position.

7. The valve assembly (10) according to claim 6, wherein the notch/dent (13e) has a pointed tip widening and/or deepening gradually towards the at least one window (13a, 13b).

8. The valve assembly (10) according to claim 6, wherein the at least one window (13a, 13b) has an inclination or ramp (13f) at a sidewall adjacent to the side where the exposure of the at least one window (13a, 13b) starts upon movement of the second disc (12) from the fully closed rotational position in the direction towards the fully open rotational position such that the free opening width of the at least one window (13a, 13b) in the thickness direction of the first disc (11) becomes gradually narrower with distance from the plane of the first sealing contact surface (11a).

9. The valve assembly (10) according to claim 1, wherein the valve assembly (10) is dimensioned so as to provide, within the rotational angular range of the relative movement between the fully closed rotational position and the fully open rotational position, a flowrate through the at least one window (13a, 13b) from dropwise up to 2 L/min.

10. The valve assembly (10) according to claim 1, wherein the rotational angular range between the fully closed rotational position and the fully open rotational position is 50°-70°.

11. The valve assembly (10) according to claim 1, wherein the first disc (11) is provided with positioning notches (17a, 17b) for preventing a rotation and defining a mounting position in a receptacle (2) of a liquid dispensing unit (1), the positioning notches (17a, 17b) being formed and/or arranged unsymmetrical about a circumference of the first disc (11).

12. The valve assembly (10) according to claim 1, wherein the second disc (12) is provided with one or more driver recess/recesses (18a, 18b) and/or protrusion/protrusions on a side opposite to the second sealing contact surface (12a), for engagement with a rotary actuator (3) of a liquid dispensing unit (1).

13. The valve assembly (10) according to claim 1, wherein the first disc (11) has a circular outer periphery, and the second disc (12) has a non-circular outer periphery with the opening portion (15a, 15b) arranged to at least partially expose the at least one window (13a, 13b) of the first disc (11) radially recessed from the outer periphery.

14. The valve assembly (10) according to claim 1, wherein the first disc (11) and/or the second disc (12) are made of a ceramic material.

15. A liquid dispensing unit (1) for a water purification system, comprising:
a supply piping (6) for purified water;
an outlet (8) for purified water; and
a valve assembly (10) according to claim 1 arranged in a receptacle (2) of a housing (5) such that the valve assembly (10) can control the volume or rate of the flow of purified water from the supply piping (6) to the outlet (8).

16. The liquid dispensing unit (1) according to claim 15, wherein the first disc (11) of the valve assembly (10) is rotationally fixed in position within the receptacle (2) such that the at least one window (13a, 13b) communicates with the outlet (8), and the second disc (12) is mounted in the receptacle (2) so as to freely float in contact with the first disc (11) and such that the first and second sealing contact surfaces (11a, 12a) are pressed against each other by the water pressure from the supply piping (6) acting on the second disc (12).

17. The liquid dispensing unit (1) according to claim 15, wherein the second disc (12) of the valve assembly (10) is engaged with a manually operable rotary actuator (3,4) for rotatingly driving the second disc (12) relative to the first disc (11) between the fully closed rotational position and the fully open rotational position.

18. The valve assembly (10) according to claim 9, wherein the dropwise flowrate through the at least one window (13a, 13b) is 20 mL/min.

19. The valve assembly (10) according to claim 10, wherein the rotational angular range between the fully closed rotational position and the fully open rotational position is about 60°.

20. The valve assembly (10) according to claim 14, wherein the first disc (11) and/or the second disc (12) are made of an aluminum oxide ceramic material.
